(19) United States
(12) Patent Application Publication
(10) Pub. No.: US 2023/0013596 A1
(43) Pub. Date: Jan. 19, 2023

(54) DEVICE FOR THE GENERATION, STORAGE AND DISTRIBUTION OF ELECTRICAL ENERGY

(71) Applicant: Klaus Robert NEUMANN TAMBURINI, Macul, Santiago de Chile (CL)

(72) Inventor: Klaus Robert NEUMANN TAMBURINI, Macul, Santiago de Chile (CL)

(21) Appl. No.: 17/768,926

(22) PCT Filed: Oct. 17, 2019
(86) PCT No.: PCT/CL2019/050101

§ 371 Date: Apr. 14, 2022

(51) Int. Cl. H02J 7/14

(52) U.S. Cl. CPC H02J 7/1415; H02J 7/1438; H02J 15/00

(57) ABSTRACT

The invention relates to a system for the generation, storage and distribution of electrical energy, which is activated by kinetic energy, generating charge as a result of movement and which comprises: one or more ion-type batteries; an electronic unit for processing and monitoring states of charge and discharge; an energy converter/transfer device; one or more alternating current generators; a current rectifier; a galvanic and/or polymer protection module that contains the system and CHAdeMO and/or CCS ports, according to region.

### TECHNICAL FEATURES

The same has one or more Type ION Accumulators, an electronic processing unit and tracking the load and discharge states, GPS And wireless communication. A power converter/transformer, one or more generators, of the alternator type, may be those of belt, rotary, wind, photovoltaic or other magnets, or the combination thereof. A current rectifier, a galvanic protection module and/or in polymers containing the same and ports of the Joint and/or CCS type, depending on the region. The aforementioned components are not restrictive.

The device/unit is activated by kinetic energy (alternating), which are to generate the charge thereof, as a result of the movement of the conveying vehicle. Said load is the production that is generated for the purposes that the software is informing (demand). This gives rise to production, without relying on the existing RED, ie, it is not “dependent” of the electric lay. Now, the same production can be inserted into the existing RED, as deemed necessary. In the event of extraordinary phenomena, it allows “moving” and to have available energy at the locations that would be necessary. In addition, the same devices/unit are themselves mobile subassemblies, which give the “availability” of electric power. Unlike the electric RED, it must serve availability as A demand; exclusively, since it does not possess the energy storage capacity.

Another direct advantage of this invention is that it helps to “level” CO2 emissions, since the mobility of the existing farm is exploited, in its majority to internal combustion, and can generate without increasing emissions. This is because it is resulting from something that is not considered. The movement of the “conveyors” of the device/unit does not take advantage of the energy generator; therefore, that generation capability is lost.

### EXAMPLES OF APPLICATION

H: To home: the build up can be transferred to the home, for proper consumption.

The invention relates to an electrolytic cell.

2M: To Micrograin: a microed, example: industrial pole, building, public or hospital type establishment or other, etc. may be fed

The device can be re inserted into the existing electrical network.

1. A device/unit for the generation, storage and distribution of electric power. The device/unit is activated by kinetic energy (alternators), which are to generate the load thereof, as a result of the movement of the conveying vehicle, said load being the production that is generated for the purposes that the software goes informing (demand), this gives rise to production, without relying on the Existing RED, ie, it is not “dependent” of the electric lay, now the same production can be inserted into the existing RED, as deemed necessary, in the case of extraordinary phenomena, allowed to “move” and have available energy at the locations that are necessary. Additionally, the same devices/unit are themselves mobile stations, which give the “availability” of electrical energy, unlike the electric RED, which must serve as demand availability; exclusively, given that it does not possess the energy storage capacity, Characterized by which comprises one or more ION type accumulators, an electronic processing unit and tracking the load and discharge states, GPS and wireless communication, a power converter/transformer, one or more generators, of the alternator type, a current rectifier, a galvanic protection module and/or in polymers containing it and ports of the joint type And/or CCS, according to the region. The aforementioned components are not restrictive.

2. The device/unit for generation according to claim 1 comprises at least one power converter/transformer less than 50 kW connected in direct current to the ION accumulators of the device/unit for the conversion and transfer of the energy stored therein to the “receiving station.”

3. The device/unit for generation according to claims 1, Characterized in that the low power converter/transformer is unidirectional for the discharge of the batteries to the “receiving station.”

4. The device/unit for generation according to claim 1 wherein the converter/transmission is monophasic.

5. The device/unit for generation according to claim 1 wherein the current rectifier accommodates the energy from the device/unit to the “receiving station.”

6. The device/unit for generation according to claim 1, wherein the galvanic isolation module and/or the polymers have different elements of the electronic converter and the device/unit to prevent the transfer of load carriers.

7. The device/unit for generation, according to claim 5, characterized in that the protection and filtering module integrates a filtering step with a slab structure LCL.

8. The device/unit for generation, according to claim 1, characterized in that the energy converter/transformer has a Joint Type connection and/or CCS, for the operation of the device through said protocol. The aforementioned components are not restrictive.

9. The device/unit for generation, according to claim 1, comprises one or more generators, of the alternator type, which may be those of belt, rotary, wind, photovoltaic or other magnets, or the combination thereof.
